(19) United States
(12) Patent Application Publication
(10) Pub. No.: US 2015/0134498 A1
(43) Pub. Date: May 14, 2015

(54) METHODS AND SYSTEMS FOR FULFILLING INVENTORY GAPS

(71) Applicant: Roshan Patel, San Ramon, CA (US)

(72) Inventor: Roshan Patel, San Ramon, CA (US)

(21) Appl. No.: 14/450,012

(22) Filed: Aug. 1, 2014

Related U.S. Application Data
(60) Provisional application No. 61/902,855, filed on Nov. 12, 2013.

(51) Int. Cl. G06Q 10/08; G06F 17/30

(52) U.S. Cl. CPC G06Q 10/087; G06F 17/30554
USPC 705/28

(57) ABSTRACT

A system, method, and computer readable medium is provided to identify and/or fulfill an inventory gap. The inventory gap indicates a lack of an item described in a search query received from a user account. The inventory gap manager identifies an inventory gap in a plurality of inventory listings. Each inventory listing is associated with a respective merchant. The inventory gap manager identifies an actual item based on the item described in the search query. The inventory gap manager monitors each the plurality of inventory listings until the actual item is available. The inventory gap manager determines the item available in a particular inventory listing is compatible with a location associated with the user account. The inventory gap manager notifies the user account the actual item is available.

### CROSS-REFERENCE TO RELATED APPLICATIONS

This application claims the benefit of priority to U.S. Provisional Patent Application Ser. No. 61/902,855, filed Nov. 12, 2013, which is hereby incorporated herein by reference in its entirety.

### TECHNICAL FIELD

This application relates to data processing. In particular, example embodiments may relate to systems and methods of publishing content data.

### BACKGROUND

Typical electronic commerce (“e-commerce) sites provide users (e.g., sellers) with computer-implemented services for selling goods or services through, for example, a website. For example, a seller may submit information regarding a good or service to the e-commerce site through a web-based interface. Upon receiving the information regarding the good or service, the e-commerce site may store the information as a listing that offers the good or service for sale. Other users (e.g., buyers) may interface with the e-commerce site through a search interface to find goods or services to purchase. For example, some typical e-commerce sites may allow the user to submit a search query that includes, for example, search terms that may be matched by the e-commerce site against the listings created by the sellers. Listings that match the submitted search query may be presented to the buyer as a search result and the buy may then select one of the listing to effectuate a purchase.

### BRIEF DESCRIPTION OF THE DRAWINGS

The present invention is illustrated by way of example, and not by way of limitation, in the figures of the accompanying drawings in which:

FIG. 1 is a network diagram depicting a publication system, according to one embodiment, having a client-server architecture configured for exchanging data over a network;

FIG. 2 is a block diagram illustrating components of an inventory gap manager, according to some example embodiments;

FIG. 3 is an architecture diagram illustrating the modules and operation of an inventory gap manager, according to an example embodiment.

FIG. 4 is a flowchart illustrating operations of a method of fulfilling inventory gaps, according to some example embodiments.

FIG. 5 shows a diagrammatic representation of machine in the example form of a computer system within which a set of instructions may be executed causing the machine to perform any one or more of the methodologies discussed herein.

### DETAILED DESCRIPTION

Example methods, systems and computer-readable media described are directed to fulfilling inventory gaps. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Although example embodiments have been described with reference to specific examples, it is to be appreciated that various modifications and changes may be made to these embodiments without departing from the broader spirit and scope of the invention. Accordingly, the specification and drawings are to be regarded in an illustrative rather than a restrictive sense.

In various embodiments, an inventory gap manager identifies an inventory gap in an inventory listing. The inventory gap indicates a lack of an item described in at least a portion of a search query received from a user account. The inventory gap manager identifies an inventory gap in a plurality of inventory listings. Each inventory listing is associated with a respective merchant. The inventory gap manager identifies at least one actual item based on the item described in the search query. The inventory gap manager monitors each one of the plurality of inventory listings until the one actual item is available in a particular inventory listing. The inventory gap manager determines the item available in the particular inventory listing is compatible with a location associated with the user account. Based on such a determination of compatibility, the inventory gap manager notifies the user account the actual item is available in the particular inventory listing.

In some embodiments, a user associated with a user account submits a search query. The search query may include a description of an item the user wishes to purchase. The inventory gap manager receives the search query. The inventory gap manager identifies a product code for the item described in the search query. The inventory gap manager searches inventory listings of items available for purchase from multiple, distinct merchants.

The inventory gap manager identifies an inventory gap based on determining that no item in the current inventory listings of the multiple merchants matches the item described in the search query. The inventory gap manager identifies similar items currently available for purchase in the inventory listings. The inventory gap manager sends display data based on the identified similar items to a computing device associated with the user account that sent the search query. The user associated with the user account may opt to request a purchase of one or more of the similar items.

If the user does not opt to request a purchase of a similar item, the inventory gap manager monitors the inventory listings of each merchant until the item's product code appears in a particular inventory listing of a merchant When the product code appears in the particular inventory listing, the inventory gap manager validates whether the item is functional at a location associated with the user. For example, the inventory gap manager determines whether a current model of the item complies with various regulations and technical specifications relevant for user's residential address.

The inventory gap manager determines whether the merchant that offers the particular inventory listing provides services to the user's location. For example, the inventory gap manager determines whether the merchant is listed as available to ship items to the user's location. Based on determining that the item complies with various regulations and technical specifications relevant for the user's location and determining that the merchant ships items to the user's location, the inventory gap manager notifies the user that the item is currently available in the particular inventory listing and available for purchase.

### Platform Architecture

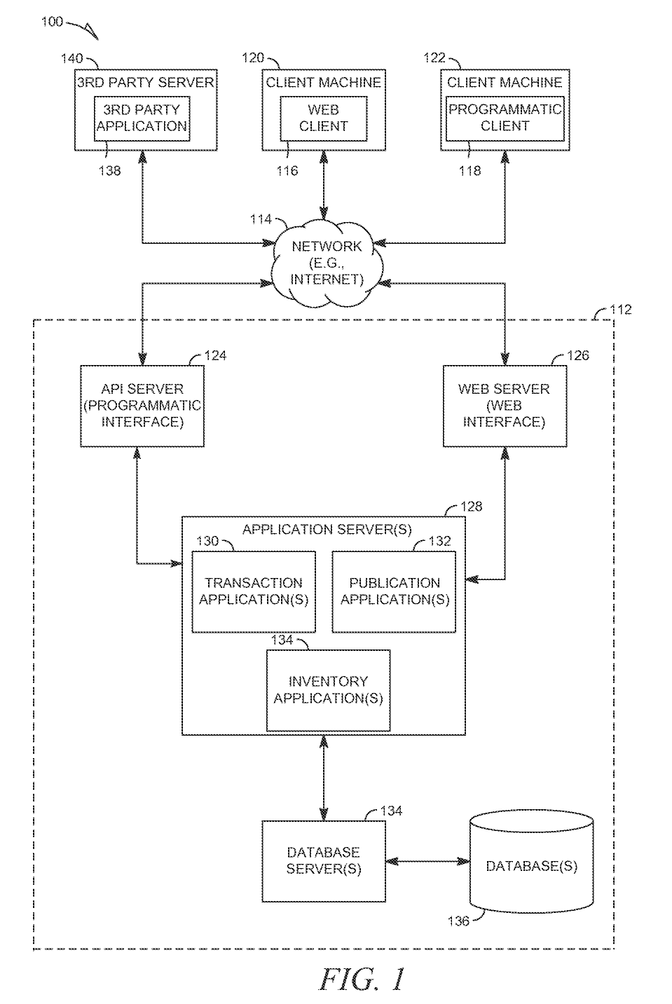

FIG. 1 is a network diagram depicting a publication system 100, according to one embodiment, having a client-server architecture configured for exchanging data over a network. The publication system 100 may be a transaction system where clients, through client machines 120, 122 and a third party server 140, may communicate, view, search, and exchange data with network based publisher 112, For example, the publication system 100 may include various applications for interfacing with client machines and client applications that may be used by users (e.g., buyers and sellers) of the system to publish items for sale in addition to facilitating the purchase and shipment of items.

The network based publisher 112 may provide server-side functionality, via a network 114 (e.g., the Internet) to one or more clients. The one or more clients may include users that utilize the network based publisher 112 as a transaction intermediary to facilitate the exchange of data over the network 114 corresponding to user transactions. User transactions may include receiving and processing item and item related data and user data from a multitude of users, such as payment data, shipping data, item review data, feedback data, etc. A transaction intermediary such as the network based publisher 112 may include one or all of the functions associated with a shipping service broker, payment service and other functions associated with transactions between one or more parties. For simplicity, these functions are discussed as being an integral part of the network based publisher 112, however it is to be appreciated that these functions may be provided by publication systems remotely and/or decoupled from the network based publisher 112.

In various embodiments, the data exchanges within the publication system 100 may be dependent upon user selected functions available through one or more client/user interfaces (UIs). The tits may be associated with a client machine, such as the client machine 120, utilizing a web client 116. The web client 116 may be in communication with the network based publisher 112 via a web server 126. The UIs may also be associated with a client machine 122 utilizing a client application 118, or a third party server 140 hosting a third party application 138. It can be appreciated in various embodiments the client machine 120, 122 may be associated with a buyer, a seller, payment service provider or shipping service provider, each in communication with the network based publisher 112 and optionally each other. The buyers and sellers may be any one of individuals, merchants, etc.

An application program interface (API) server 124 and a web server 126 provide programmatic and web interfaces to one or more application servers 128. The application servers 128 may host one or more other applications, such as transaction applications 130 and publication applications 132. The application servers 128 may be coupled to one or more data servers 134 that facilitate access to one or more storage devices, such as the data storage 136.

The transaction applications 130 may provide a number of payment processing modules to facilitate processing payment information associated with a buyer purchasing an item from a seller. The publication applications 132 may include various modules to provide a number of publication functions and services to users that access the network based publisher 112. For example, these services may include, inter alia, formatting and delivering search results to a client. The inventory applications 134, such as an inventory gap manager, may include various modules to provide a number of functions and services related to identifying and fulfilling inventory gaps. For example, these services may include, inter alia, identifying gaps in an inventory based on searches performed by users of the network-based publisher 112, requesting fulfillment of an inventory gap, and surfacing the fulfillment to the users of the network-based publisher 112.

FIG. 1 also illustrates an example embodiment of a third party application 138, which may operate on a third party server 140 and have programmatic access to the network based publisher 112 via the programmatic interface provided by the API server 124. For example, the third party application 138 may utilize various types of data communicated with the network based publisher 112 and support one or more features or functions normally performed at the network based publisher 112. For example, the third party application 138 may receive a copy of all or a portion of the data storage 136 that includes buyer shipping data and act as the transaction intermediary between the buyer and seller with respect to functions such as shipping and payment functions. Additionally, in another embodiment, similar to the network based publisher 112, the third party application 138 may also include modules to perform operations pertaining to payment, shipping, etc. in yet another embodiment, the third party server 140 may collaborate with the network based publisher 112 to facilitate transactions between buyers and sellers, such as by sharing data and functionality pertaining to payment and shipping, etc.]

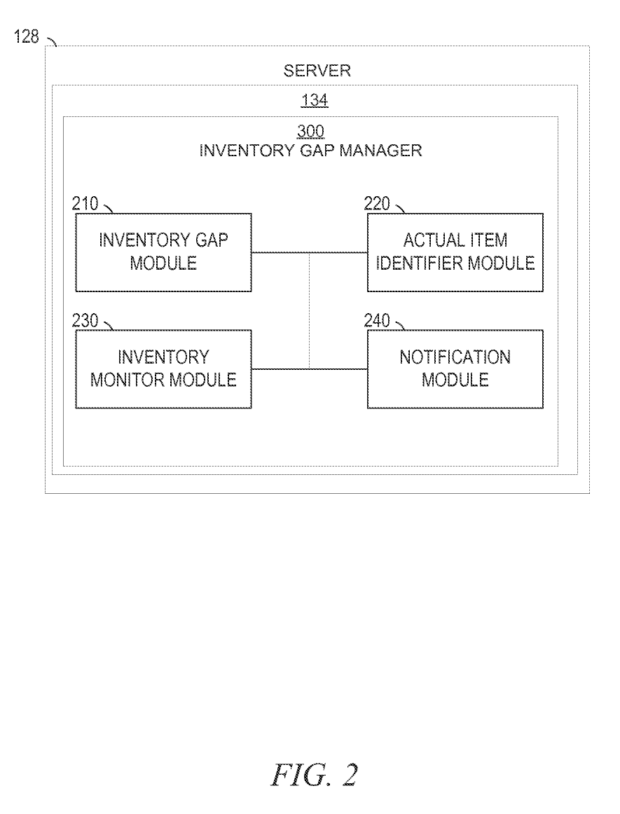

FIG. 2 is a block diagram illustrating components of an inventory gap manager 300, according to some example embodiments. The components communication with each other to perform the operations of the inventory gap manager. The server machine 128 is shown as including an inventory gap module 210, an actual item identifier module 220, an inventory monitor module 230 and a notification module 240, ail configured to communicate with each other (e.g., via a bus, shared memory, or a switch).

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The inventory gap module 210 may be a hardware-implemented module which manages, controls, stores, and accesses information of an inventory listing(s). The inventory gap module 210 of the inventory gap manager accesses an inventory listing of a plurality of items for sale from a plurality of sellers. The inventory gap module 210 searches the inventory listing for an item described in at least a portion of a search query received from a user account. The inventory gap module 210 determines an inventory gap based on an absence of a product code for an item described in at least a portion of the search query.

The actual item identifier module 220 may be a hardware-implemented module which manages, controls, stores, and accesses information describing a plurality of items. Such information describing a plurality of items can be a product code, a product description, product specifications and product technical requirements.

The inventory monitor module 230 may be a hardware-implemented module which manages, controls, stores, and accesses information for monitoring an inventory listing. The inventory monitor module 230 determines a search interval and monitors the inventory listing according to the search interval. The inventory monitor module 230 monitors the inventory listing for a presence of one or more product codes for items described in a search query.

The notification module 240 may be a hardware-implemented module which manages, controls, stores, and accesses information for notifying a user account that an item is present in the inventory listing and available for purchase. The notification module 240 sends a notification to the user account based on determining a compatibility between a location described in the user account and he item.

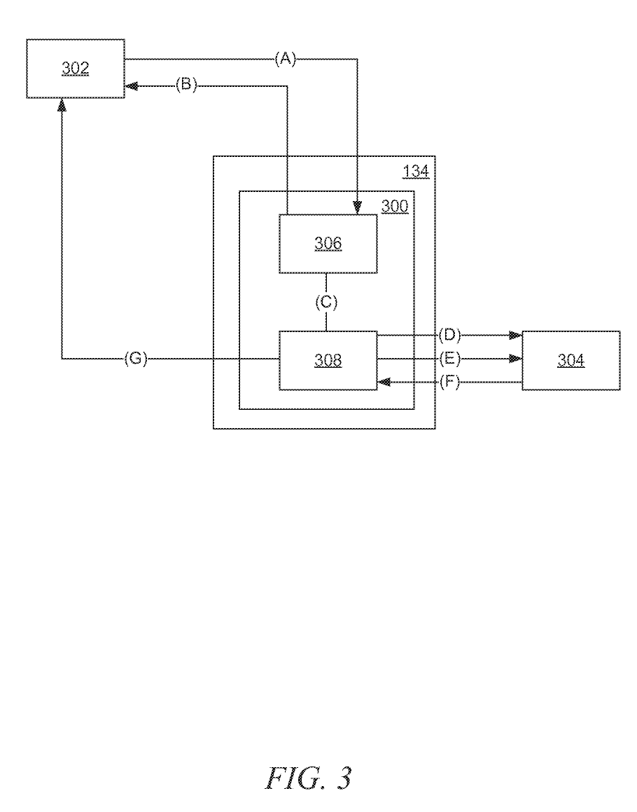

FIG. 3 is an architecture diagram illustrating the modules and operation of an inventory gap manager 300, according to an example embodiment. The modules, systems, and/or engines shown in FIG. 3 represent a set of executable software instructions and the corresponding hardware (e.g., memory and processor) fur executing the instructions. However, one skilled in the art will readily recognize that various additional functional modules and engines may be used with the inventory application 134 to facilitate additional functionality that is not specifically described herein. Furthermore, the various functional modules and engines depicted in FIG. 3 may reside on a single server computer, or may be distributed across several server computers in various arrangements.

As shown in FIG. 3, the inventory gap manager 300 may include a search query engine 306 and an inventory finder module 308 that are communicatively coupled to a client device 302 and a merchant interface 304.

The client device 302 may be a computer system operated by a user (e.g., a buyer) searching the network-based publisher for content, such as listings of goods or services. In an example embodiment, the client device 302 may be configured to transmit a search query to the inventory applications 134. A search query may be data that specifies search terms and properties characterizing an item that the buyer is seeking to identify.

The search query engine 306 may be a computer-implemented module configured to process search queries received from the client device 302. The search query engine 306 may process a search query by using the search query to search the database 136 for matching content. The search query engine 306 may then generate a search result from the content found to be matching the search query. In some cases, the search query engine 306 may log data derived from processing the search query submitted by the client device 302. For example, the search query engine 306 may log the user identifier for the user operating the client device 302 that submitted the search query, some or all of the search query, and data derived from the search result (e.g., a number of matching content, identifiers of the matching content, etc.).

The inventory finder module 308 may be a computer-implemented module configured to identify gaps in an inventory, identify merchants (e.g. sellers) that may fill the gap of the identified inventory, request the identified merchant to fulfill the identified gap, and surface content that fills the identified gap to a user previously searching for content missing due to the gap. In some embodiments, it is understood that the inventory finder module 308 includes the inventory gap module 210, actual item identifier module 220, inventory monitor module 230 and the notification module 240. In various embodiments, the inventory finder module 308 interacts and communicates with the modules 210, 220, 230, 240, 306 to carry out the operations described herein.

As FIG. 3 shows, the inventory gap manager 300 may be communicatively coupled to the merchant interface 304 via the inventory finder module 308. Similar to the content publisher 112, the merchant interface 304 may be a computer system that lists goods or services for sale. However, the content publisher 112 and merchant interface may be operated by different entities. For example, the content publisher 112 may be operated by eBay® and the merchant interface 304 may be operated by BestBuy®.

It is understood, that in some embodiments, the inventory gap manager 300 may be communicatively coupled to a plurality of merchant interfaces and that interactions between each of the plurality of merchant interfaces and the inventory gap manager 300 are similar to interactions illustrated in FIG. 3 between the inventory gap manager 300 and the merchant interface 304.

The operation of the client device 302, the inventory gap manager 300, and the merchant interface 304 is now described, according to an example embodiment. To begin, the client device 302 may communicate a search query to the search query engine 306 in the inventory gap manager 300. This is shown as message A in FIG. 3. Responsive to receiving the search query from the client device 302, the search query engine 306 may process the search query. As described above, processing a search query may involve using the search query to search the database 136 of FIG. 1 for content matching the search terms and properties specified in the search query. The search query engine 306 may then generate search results from the content matching the search query and send the search results back to the client device. Message B of FIG. 3 represents the search results being communicated back to the client device 302.

It is to be appreciated that in some cases, the search query may result in a search result that includes a number of listings that is at or below a minimal threshold (e.g. zero). In these cases, it can be said that the inventory of the content publisher 112 includes a gap for that item being represented by the search query. That is, a buyer may be looking for an item to purchase but that item is not offered. for sale through the content publisher 112.

At message C, the inventory finder module 308 may identify a gap in the inventory of items offered for sale by the content publisher 112. A gap in the inventory may be identified according to many different techniques. For example, according to one example embodiment, when the search query engine 306 generates a search result that is at or below the minimal threshold, the search query engine 306 may signal the inventory finder module 308 to this gap. In other cases, the search query engine 306 may log in data derived from processing the search query, such as a time stamp, user identifier, search query, search results (or data derived therefrom, such as a number of items matching the search query), and the like. The inventory finder module 308 may then parse the log for the search queries to identify the search queries linked to the search results below or at the minimal threshold.

Once the inventory finder module 308 identifies the gap in inventory, the inventory finder module 308 may then identify a merchant that offers an item for sale that may fill the gap. This is shown as message D in FIG. 3. The inventory finder module 308 may identify the merchant by scraping the items offered for sale by a merchant through the merchant interface 304. In some cases, scraping the item may involve sending a web request to the merchant interface with a URL that includes a search query that is based on the search query that resulted in the search result below or at the minimal threshold. If the merchant interface 304 returns a search result that includes an item that would fill the gap in inventory, the inventory finder module 308 may identify the merchant linked to the merchant interface 304 as offering an item that may fill the inventory gap.

At message E of FIG. 3, the inventory finder module 308 may then send a fulfillment request to the merchant interface 304. The fulfillment request may include an invitation for the merchant to list the item for sale on the site hosted by the content publisher 112. Thus, the fulfillment request may include an identifier associated with the item that may be missing from the inventory of the content publisher 112.

Once the fulfillment request is received by the merchant interface 304, the merchant may decide to fulfill the inventory gap by listing the item (e.g., as may be identified by the fulfillment request) through the content publisher 112. Thus, the merchant interface may then list the item that fills the inventory gap by sending a fulfillment response (represented as message F of FIG. 3) to the inventory tinder module 308. The fulfillment response may include data capable of being listed by the content publisher 112.

When the item that fills the inventory gap is added to the content publisher 112, the inventory finder 308 may send an inventory found update to the client device 302 to notify the user that the item that the user previously searched for but was missing from the inventory of the content publisher is now available. This is shown as message G of FIG. 3.

It is to be appreciated that the operations involved with messages C-G of FIG. 3 may occur substantially real-time relative to the search query engine 306 receiving the search request (e.g., message A) or as part of a batch process that is performed periodically (daily, weekly, monthly, and so on).

It is to be appreciated that various embodiments may perform more or less operations described herein. For example, some embodiments may filter or pre-process the query terms to fix misspellings or typos, or to filter out search queries not related to catalog products (e.g., products offered for sale by merchant partners). This preprocessing may result in search queries more directly related to the items or products that are of interest to the users.

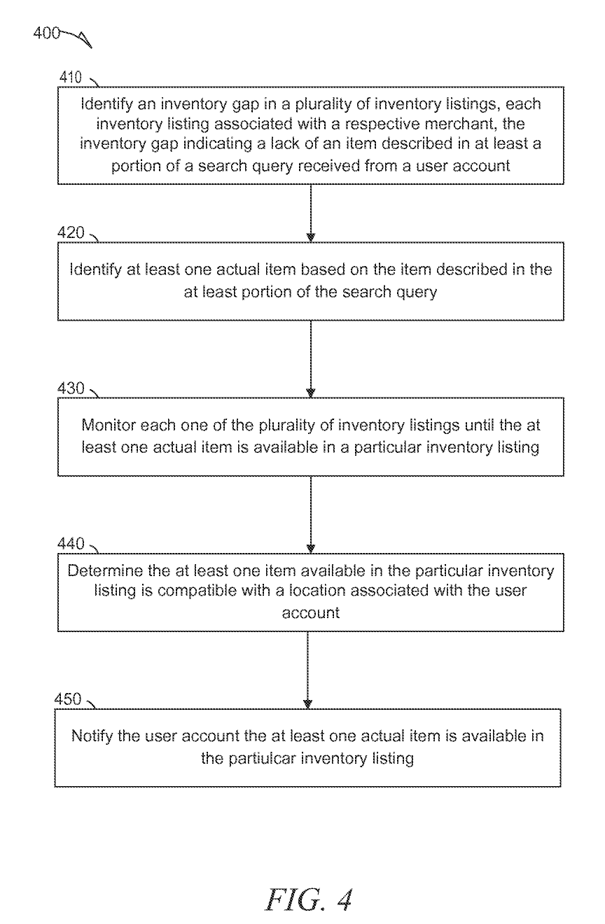

FIG. 4 is a flowchart illustrating operations of a method 400 of fulfilling inventory gaps, according to some example embodiments. Operations in the method 600 may be performed by the server 128, using modules described above with respect to FIGS. 2 and 3. As shown in FIG. 4, the method 400 includes operations 410, 420, 430 and 440.

At step 410, the inventory gap manager 300 identifies an inventory gap in a plurality of inventory listings. Each inventory listing is associated with a respective merchant. The inventory gap indicates a lack of an item described in at least a portion of a search query received from a user account.

In one embodiment, a user associated with a user account submits a search query. The search query may include a description of an item the user wishes to purchase. The inventory gap manager 300 receives the search query. The inventory gap manager 300 identifies a product code for each item described in the search query. The inventory gap manager 300 searches the inventory listings of items available for purchase from each merchant.

In some embodiments, the inventory gap manager 300 searches the inventory listings of multiple, distinct sellers at various search intervals. The inventory gap manager 300 detects and tracks any absence of the item identified in the inventories of the respective sellers.

At step 420, the inventory gap manager 300 identifies at least one actual item based on the item described in the at least portion of the search query. The inventory gap manager 300 parses the item described in the search query and matches the parsed search query with a product code for the item(s) described in the search query.

At step 430, the inventory gap manager 300 monitors each one of the plurality of inventory listings until the at least one actual item is available in a particular inventory listing. In some embodiments, the inventory gap manager 300 monitors each inventory listing of each merchant for a presence of the product code. Presence of the product code reflects that a particular merchant is offering the item for sale.

At step 440, the inventory gap manager 300 determines that at least one actual item available in the particular inventory listing is compatible with a location associate with the user account. For example, when the inventory gap manager 300 detects presence of the product code in a particular inventory listing of a merchant, the inventory gap manager 300 validates compatibility between the user and that merchant. In some embodiments, the inventory gap manager 300 determines a location associated with the user account of the user that submitted the search query. The inventory gap manager 300 accesses a user profile in the user account to identify an address to which the item will be shipped should the user decide to purchase the item from the merchant.

The inventory gap manager 300 accesses data related to technical specifications and regulatory requirements for the location associated with the user profile. Such data can describe voltage requirements, communications standards and safety requirements. The inventory gap manager 300 compares such data against information about the item for sale by the merchant in order to determine if the item for sale can be sold to a buyer at the location listed in the user profile.

In addition, the inventory gap manager 300 accesses data about the particular seller to determine if the particular seller sells items to a buyer at the location listed in the user profile and/or ships items to the location listed in the user profile.

At step 450, the inventory gap manager 300 notifies the user account the at least one actual item is available in the particular inventory listing. The inventory gap manager 300 sends a notification to the user account based on determining that the item for sale by the merchant is compatible with the location associated with the user account and that the merchant services the location associated with the user account.

When these effects are considered in aggregate, one or more of the methodologies described herein may obviate a need for certain efforts or resources that otherwise would be involved to identify and/or fulfill an inventory gap. Efforts expended by a user to identify and/or fulfill an inventory gap may be reduced by one or more of the methodologies described herein. Computing resources used by one or more machines, databases, or devices (e.g., within the network environment 100) may similarly be reduced. Examples of such computing resources include processor cycles, network traffic, and/or memory.

### Exemplary Computer Systems

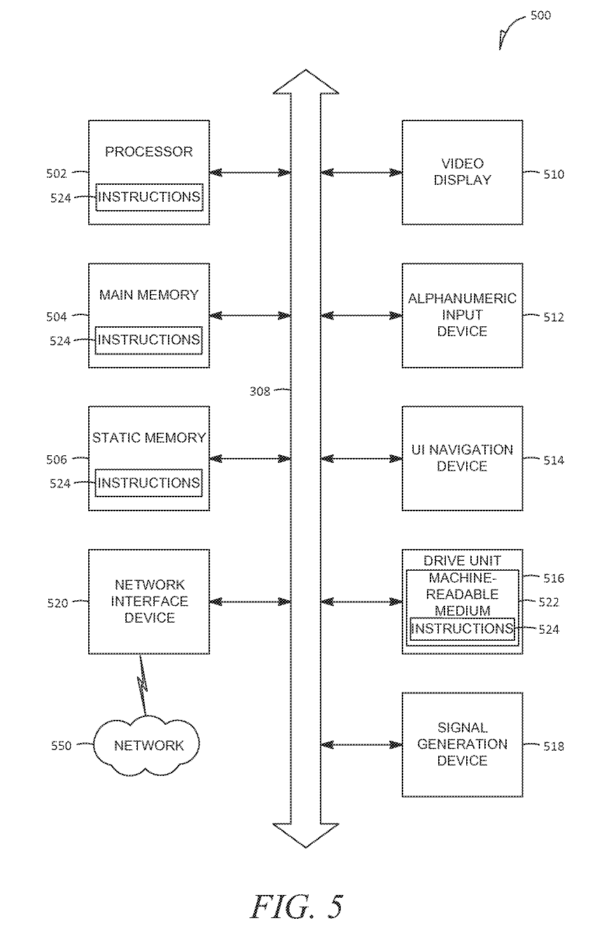

FIG. 5 shows a diagrammatic representation of machine in the example form of a computer system 500 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 300 also includes an alphanumeric input device 512 (e.g., a keyboard), a user interface (UI) navigation device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 520 utilizing any one of a number of well-known transfer protocols (e.g., HTTP).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

The Abstract of the Disclosure is provided to comply with 37 C.F.R. §1.72(b), requiring an abstract that will allow the reader to quickly ascertain the nature of the technical disclosure, it is submitted with the understanding that it will not be used to interpret or limit the scope or meaning of the claims. In addition, in the foregoing Detailed Description, it can be seen that various features are grouped together in example embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Furthermore, the following claims are hereby incorporated into the Detailed Description, with each claim standing on its own as a separate embodiment.

1. A computer system comprising:
a processor;
a memory device holding an instruction set executable on the processor to cause the computer system to perform operations comprising:
identifying an inventory gap in a plurality of inventory listings, each inventory listing associated with a respective merchant, the inventory gap indicating a lack of an item described in at least a portion of a search query received from a user account;
identifying at least one actual item based on the item described the at least portion of the search query;
monitoring each one of the plurality of inventory listings until the at least one actual item is available in a particular inventory listing;
determining the at least one item available in the particular inventory listing is compatible with a location associated with the user account; and
notifying the user account the at least one actual item is available in the particular inventory listing.

2. The computer system as in claim 1, wherein identifying at least one actual item based on the at least portion of a search query comprises:
identifying at least one product code that represents the at least one actual item.

3. The computer system as in claim 2, wherein monitoring each one of the plurality of inventory listings until the at least one actual item is available in the particular inventory listing comprises:
determining a search interval; and
searching each one of the plurality of inventory listings according to the search interval for a presence of the product code.

4. The computer system as in claim 1, wherein determining the at least one item available in the particular inventory listing is compatible with a location associated with the user account comprises:
identifying the location in a user profile of the user account;
determining the at least one actual item available in the particular inventory listing is functional at the location in the user profile;
determining a merchant fur the particular inventory listing services the location in the user profile; and
triggering a notification to the user account upon determining the at least one actual item available in the particular inventory listing is functional at the location in the user profile and determining the merchant for the particular inventory listing services the location in the user profile.

5. The computer system as in claim 1, further comprising:
generating display data based on the at least a portion of the search query, the display data comprising a plurality of items similar to the item described in at least a portion of the search query; and
transmitting the display data to a computing device associated with the user account.

6. The computer system as in claim 5, further comprising:
receiving a selection of an item from the plurality of s provide in the display data; and
initiating a transaction between the user account and a merchant of the selected item.

7. The computer system as in claim 6, wherein monitoring of the inventory listing until the at least one actual item is available in the inventory listing comprises:
based on initiating the transaction, halting the monitoring of each one of the inventory listings.

8. A computer-implemented method comprising:
identifying an inventory gap in a plurality of inventory listings, each inventory listing associated with a respective merchant, the inventory gap indicating a lack of an item described in at least a portion of a search query received from a user account;
identifying at least one actual item based on the item described in the at east portion of the search query;
monitoring each one of the plurality of inventory listings until the at least one actual item s available in a particular inventory listing;
determining the at least one item available in the particular inventory listing is compatible with a location associated with the user account; and
notifying the user account the at least one actual item is available in the particular inventory listing.

9. The computer system as in claim 8, wherein identifying at least one actual item based on the at least portion of a search query comprises:
identifying at least one product code that represents the at least one actual item.

10. The computer system as in claim 9, wherein monitoring each one of the plurality of inventory listings until the at least one actual item is available in the particular inventory listing comprises:
determining a search interval; and
searching each one of the plurality of inventory listings according to the search interval for a presence of the product code.

11. The computer system as in claim 8, wherein determining the at least one item available in the particular inventory listing is compatible with a location associated with the user account comprises:
identifying the location in a user profile of the user account;
determining the at least one actual item available in the particular inventory listing is functional at the location in the user profile;
determining a merchant fur the particular inventory listing services the location in the user profile; and
triggering a notification to the user account upon determining the at least one actual item available in the particular inventory listing is functional at the location in the user profile and determining the merchant for the particular inventory listing services the location in the user profile.

12. The computer system as in claim 8, further comprising:
generating display data based on the at least a portion of the search query, the display data comprising a plurality of items similar to the item described in at least a portion of the search query; and
transmitting the display data to a computing device associated with the user account.

13. The computer system as in claim 12, further comprising:
receiving a selection of an item from the plurality of items provide in the display data; and
initiating a transaction between the user account and a merchant of the selected item.

14. The computer system as in claim 13, wherein monitoring of the inventory listing until the at least one actual item is available in the inventory listing comprises:
based on initiating the transaction, halting the monitoring of each one of the inventory listings.

15. A non-transitory computer-readable medium storing executable instructions thereon, which, when executed by a processor, cause the processor to perform operations including:
identifying an inventory gap in a plurality of inventory listings, each inventory listing associated with a respective merchant, the inventory gap indicating a lack of an item described in at least a portion of a search query received from a user account;
identifying at least one actual item based on the item described in the at east portion of the search query;
monitoring each one of the plurality of inventory listings until the at least one actual item is available in a particular inventory listing;
determining the at least one item available in the particular inventory listing is compatible with a location associated with the user account; and
notifying the user account the at least one actual item is available in the particular inventory listing.

16. The computer system as in claim 15, wherein identifying at least one actual item based on the at least portion of a search query comprises:
identifying at least one product code that represents the at least one actual item.

17. The computer system as in claim 16, wherein monitoring each one of the plurality of inventory listings until the at least one actual item is available in the particular inventory listing comprises:
determining a search interval; and
searching each one of the plurality of inventory listings according to the search interval for a presence of the product code.

18. The computer system as in claim 15, wherein determining the at least one item available in the particular inventory listing is compatible with a location associated with the user account comprises:
identifying the location in a user profile of the user account;
determining the at least one actual item available in the particular inventory listing is functional at the location in the user profile;
determining a merchant fur the particular inventory listing services the location in the user profile; and
triggering a notification to the user account upon determining the at least one actual item available in the particular inventory listing is functional at the location in the user profile and determining the merchant for the particular inventory listing services the location in the user profile.

19. The computer system as in claim 15, further comprising:
generating display data based on the at least a portion of the search query, the display data comprising a plurality of items similar to the item described in at least a portion of the search query; and
transmitting the display data to a computing device associated with the user account.

20. The computer system as in claim 19, further comprising:
receiving a selection of an item from the plurality of items provide in the display data;
initiating a transaction between the user account and a merchant of the selected item; and
based on initiating the transaction, halting the monitoring of each one of the inventory listings.
